(19) United States
(12) Patent Application Publication
(10) Pub. No.: US 2017/0259854 A1
(43) Pub. Date: Sep. 14, 2017

(54) VAN CONSTRUCTION

(71) Applicant: Independent Protection Company, Inc. d/b/a, Goshen, IN (US)

(72) Inventors: MATT SAUSAMAN, Syracuse, IN (US); Scott Jacobson, Nappanee, IN (US); Dusty Nabinger, Leesburg, IN (US); Shannon Sausaman, Leesburg, IN (US)

(21) Appl. No.: 15/434,149

(22) Filed: Feb. 16, 2017

Related U.S. Application Data
(60) Provisional application No. 62/307,910, filed on Mar. 14, 2016.

(51) Int. Cl. B62D 23/00; B62D 25/06; B62D 27/02; B62D 25/02

(52) U.S. Cl. CPC B62D 23/005; B62D 25/02; B62D 25/06; B62D 27/023; B62D 27/026

(57) ABSTRACT

Aspects of the disclosure relate to passenger or cargo vans. Features include the structure and assembly process using a framing structure which defines and supports a rearward compartment. In certain embodiments, the framing structure can be formed as modular subpanels which can be easily assembled while also providing superior strength and weight characteristics. In certain embodiments, specialized joints are arranged to connect the subpanels. Exterior shell portions and optionally windows can be mounted to the framing structure to form a rearward compartment.

This application claims priority to Application Ser. No. 62/307,910 filed on Mar. 14, 2016, incorporated herein by reference.

### FIELD OF THE INVENTION

This disclosure relates generally to vehicles and more particularly to apparatuses and processes for constructing vans and other vehicles for passengers or cargo.

### BACKGROUND OF THE INVENTION

In certain embodiments, aspects of the disclosure relate to passenger or shuttle vans.

Such vans are often based on a truck chassis, which includes an engine and cab section at the front and a support chassis section extending rearward. The passenger compartment or cargo area is then built on and supported by the rearward chassis section. In many prior methods of manufacture, the passenger compartment or cargo area is assembled in place on the rearward chassis section. Often the support frame for the passenger compartment or cargo area is formed in place of individually welded steel tubular members and wall panels are then mounted on the support frame. Such assembly methods can be time and labor intensive, increasing the cost of the vehicle.

To meet industry strength and durability standards, passenger compartment or cargo areas are often made with steel support members. This can create significant weight on the chassis, decreasing the usable payload weight capacity and contributing to lower gas mileage and higher wear and tear on the vehicle, and in turn increased costs.

There is a need for improved apparatuses and processes for constructing vans and other vehicles for passengers or cargo.

### SUMMARY OF THE INVENTION

Aspects of the disclosure relate to passenger or cargo vans. Features include the structure and assembly process using a framing structure which defines and supports a rearward compartment. In certain embodiments, the framing structure can be formed as modular subpanels which can be easily assembled while also providing superior strength and weight characteristics. In certain embodiments, specialized joints are arranged to connect the subpanels. Exterior shell portions and optionally windows can be mounted to the framing structure to form a rearward compartment.

In certain representative embodiments, a method of assembling a van includes providing a truck chassis including a floor section where the floor section defines at least one longitudinal base groove along a side of the floor section. A first sidewall panel is provided having a height and having a base joint portion. The first sidewall panel is initially oriented in a non-vertical orientation with the base joint portion adjacent to the base groove. The first sidewall panel is the rotated to a substantially vertical orientation so that the base joint portion enters and engages the base groove. In some embodiments, a first sidewall panel is provided and initially oriented in a non-vertical orientation with the base joint portion adjacent to a second base groove in the floor section. The second sidewall panel is then rotated to a substantially vertical orientation so that the base joint portion enters and engages the second base groove.

In some embodiments, each sidewall subpanel has a height defined between a longitudinal base extension portion having a hooked cross-section and an upper edge defining a longitudinal upper tab portion. The hooked cross-section may engage a complimentary shaped base groove. In some embodiments, the base groove may be arranged with an outer wall portion with an upward facing surface and an inner wall portion with an upward facing surface wherein the upward facing surface of the inner wall portion is arranged at a lower height than the upward facing surface of the outer wall portion. In some versions, the engagement of the base joint portion and the base groove prevent rotation of the sidewall panel past vertical.

In certain aspects, a roof subpanel is provided defining a pair longitudinal roof grooves along opposing sides of the roof subpanel. The roof subpanel is aligned and lowered to introduce the upper tab portions of the first and second sidewall panels into the pair of roof grooves.

Optionally, an adhesive can be inserted into each base groove prior to rotating the respective sidewall subpanel to a vertically orientation. Similarly, an adhesive can be inserted into each roof groove prior to introducing the upper tab portions of the first and second sidewall panels into the pair of roof grooves. The adhesive may have elastic and/or vibration damping properties.

The rearward compartment may be formed as an exterior shell portion arranged on a framing structure or cage, which is in turn supported on the van chassis. The shell may include a front, a left side, a right side, a rear and a roof. In some aspects, each side of the shell may be formed from a shell panel, with each shell panel formed as one continuous and integral piece extending across the length and width of a respective framing subpanel.

In certain embodiments the van includes a passenger windshield positioned and mounted above the driver's windshield. This provides enhanced sight options and increased internal light for passengers who may sit several inches higher than the driver. The van shell and passenger windshield can be arranged to optically continue the shape, profile and angle of the driver windshield with a minimum of noticeable transition.

In a further aspect, the van shell may include a contoured roof panel. A central surface of the roof panel is angled downward and rearward along its length. A pair of side wings extend upward from the central surface along the opposing lateral edges. The roof panel and support structure can support and hide an air conditioner unit visually and aerodynamically. The interior of the side wings may be used for support and storage aspects for the van.

Further objects, features and advantages of the present invention shall become apparent from the detailed drawings and descriptions provided herein.

### BRIEF DESCRIPTION OF THE DRAWINGS

FIG. 1 is an illustration of a representative van according to certain aspects of the disclosure.

FIG. 2 is a left side view of the van of FIG. 1.

FIG. 3 is a front view of the van of FIG. 1.

FIG. 4 is a rear view of the van of FIG. 1.

FIG. 5 is a top view of the van of FIG. 1.

FIG. 6 is a perspective view of a framing structure usable in the van of FIG. 1.

FIG. 7 is a perspective view of a floor subpanel usable in the framing structure of FIG. 6.

FIG. 8 is a perspective view of an example crossmember usable in the framing structure of FIG. 6.

FIG. 9 is a perspective view of a left side subpanel usable in the framing structure of FIG. 6.

FIG. 10 is a perspective view of a right side subpanel usable in the framing structure of FIG. 6.

FIG. 11 is a perspective view of a roof subpanel usable in the framing structure of FIG. 6.

FIGS. 12A and 12B illustrate cross-sectional views of a joint between a floor subpanel and a side subpanel.

FIGS. 13A and 13B illustrate cross-sectional views of a joint between a side wall subpanel and a roof subpanel.

FIG. 14 illustrates an example side panel usable in the van of FIG. 1.

FIG. 15 is a cut-away view illustrating an example interior of the van of FIG. 1.

### DESCRIPTION OF PREFERRED EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles of the disclosure being contemplated as would normally occur to one skilled in the art to which the disclosure relates.

This disclosure relates generally to vehicles and more particularly to apparatuses and processes for constructing vans and other vehicles for passengers or cargo. In certain embodiments, as illustrated, aspects of the disclosure relate to passenger or shuttle vans. Such vans are often based on a truck chassis, which includes an engine and cab section at the front and a support chassis section extending rearward. The passenger compartment or cabin is supported by the rearward chassis section. The passenger compartment is built to transition and merge into an open rear section of the cab. In other embodiments, aspects of the present disclosure can be used in constructing and assembling other types of vehicles such as cargo vans, buses, and recreational vehicles, to name a few.

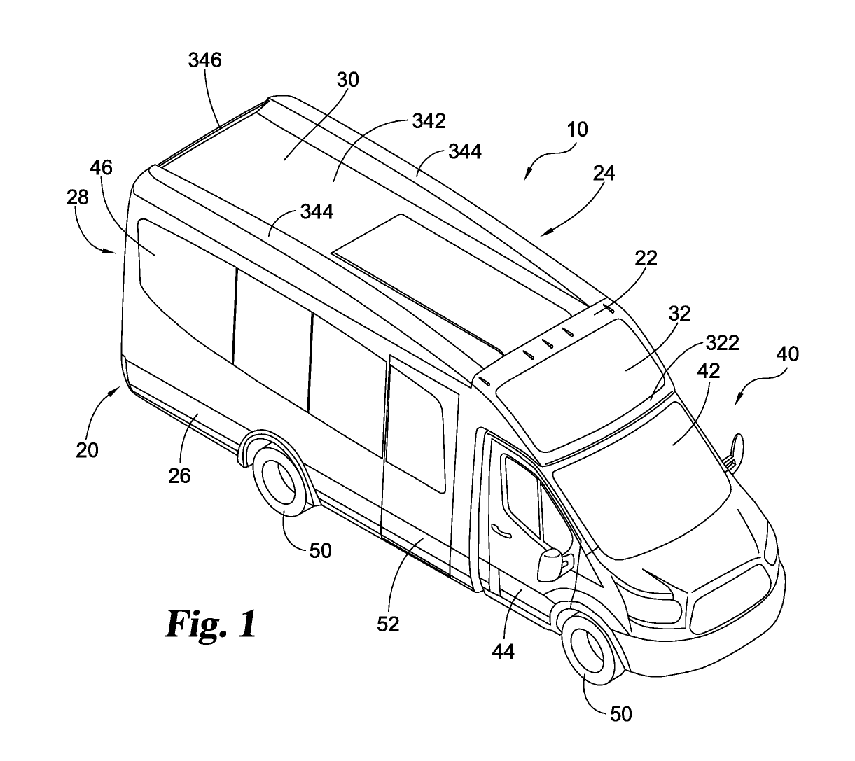

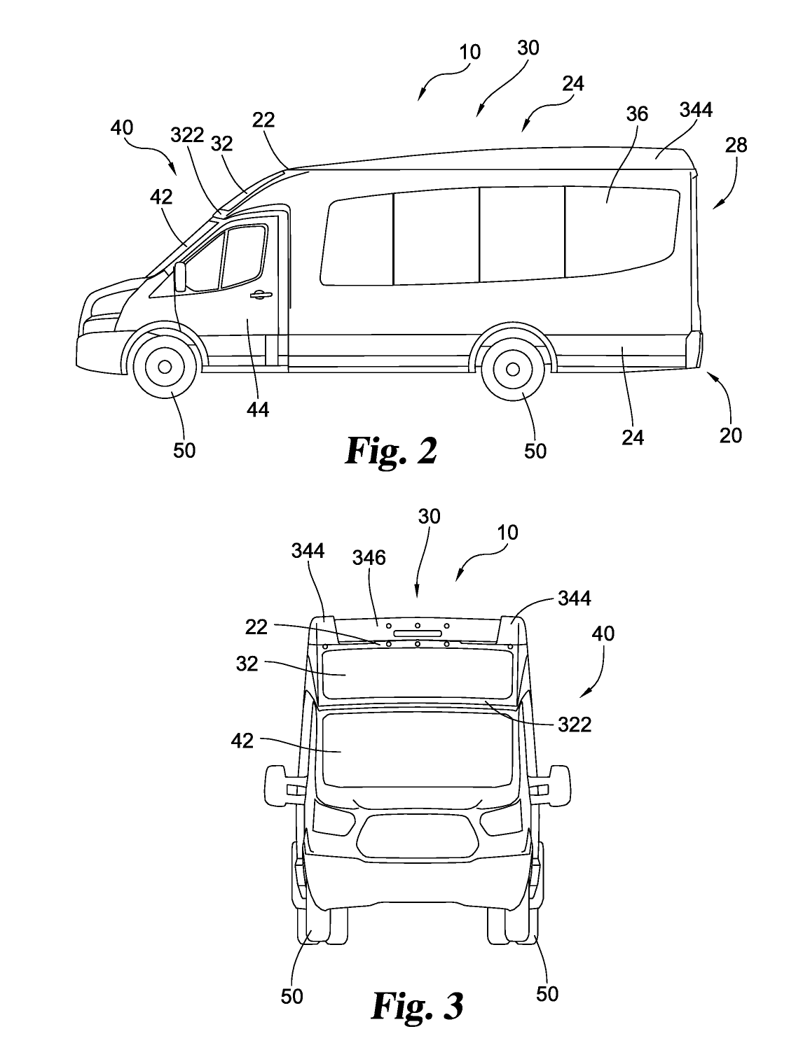

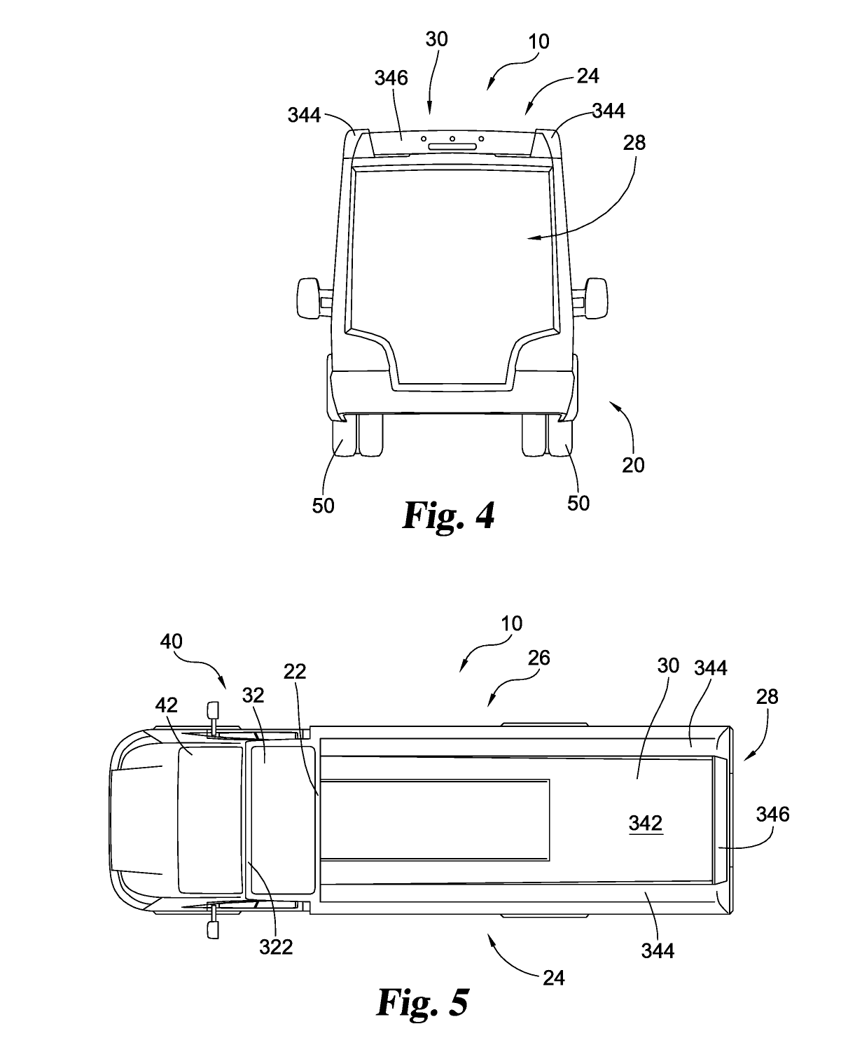

An exterior of a representative van 10 is illustrated in FIGS. 1-5. Van 10 includes forward cab section 40 and a rearward compartment 20. The cab section includes an engine (not shown), as well as an area for a driver's seat, driver, steering wheel and control panel, and may include an individual passenger seat. The cab section 40 includes a driver's windshield 42, and in some embodiments a pair of forward doors 44 for a driver and a passenger. Alternate embodiments may include a door on only one side. Rearward compartment 20 may include a passenger door 52, typically on the curb-side of the vehicle. A set of steps may assist passengers in moving into or out of the rearward compartment. Alternate options can also be used to enhance accessibility. A transition section mates the cab section 40 to the rearward compartment 20. Van 10 is supported on conventional wheels 50.

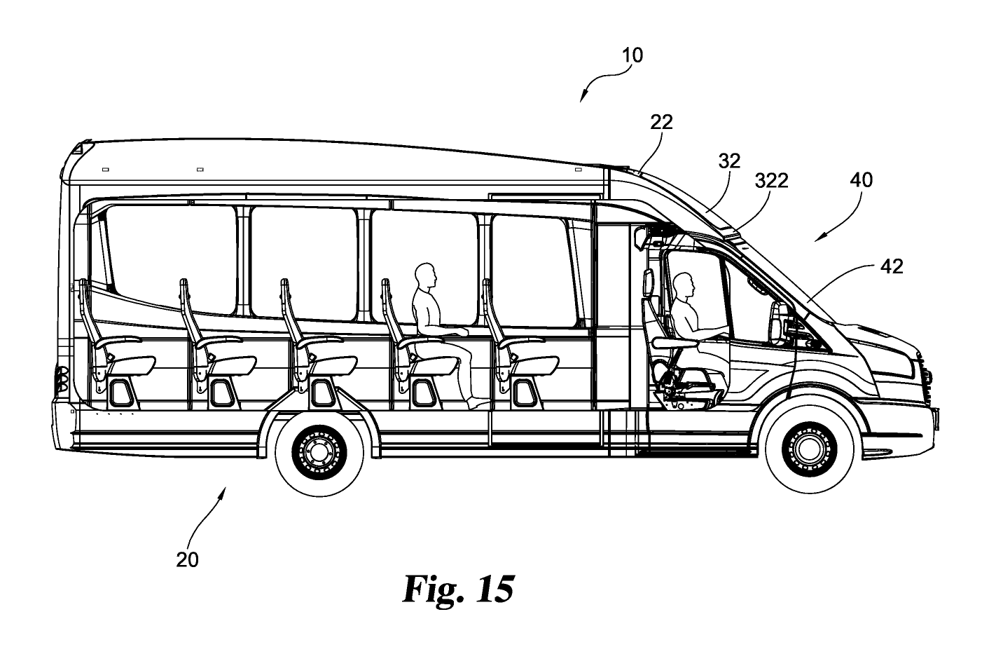

As illustrated, rearward compartment 20 may be formed as an exterior shell portion arranged on a framing structure or cage 110, which is in turn supported on the van chassis. The shell includes a front 22, a left side 24, a right side 26, a rear 28 and a roof 30. According to certain embodiments, the shell features a passenger windshield 32 and respective left and right side window arrangements 36, 46. The rear side 28 may also include windows and/or a door. The interior of van 10 (FIG. 15) may include finishing details for function or aesthetics such as floor and wall coverings, trim, etc. The interior of rearward compartment 20 may contain seating such as benches or individual chairs in rows or around the perimeter and/or may contain storage racks, storage compartments, or other attributes for the use and convenience of the passengers or for storing cargo.

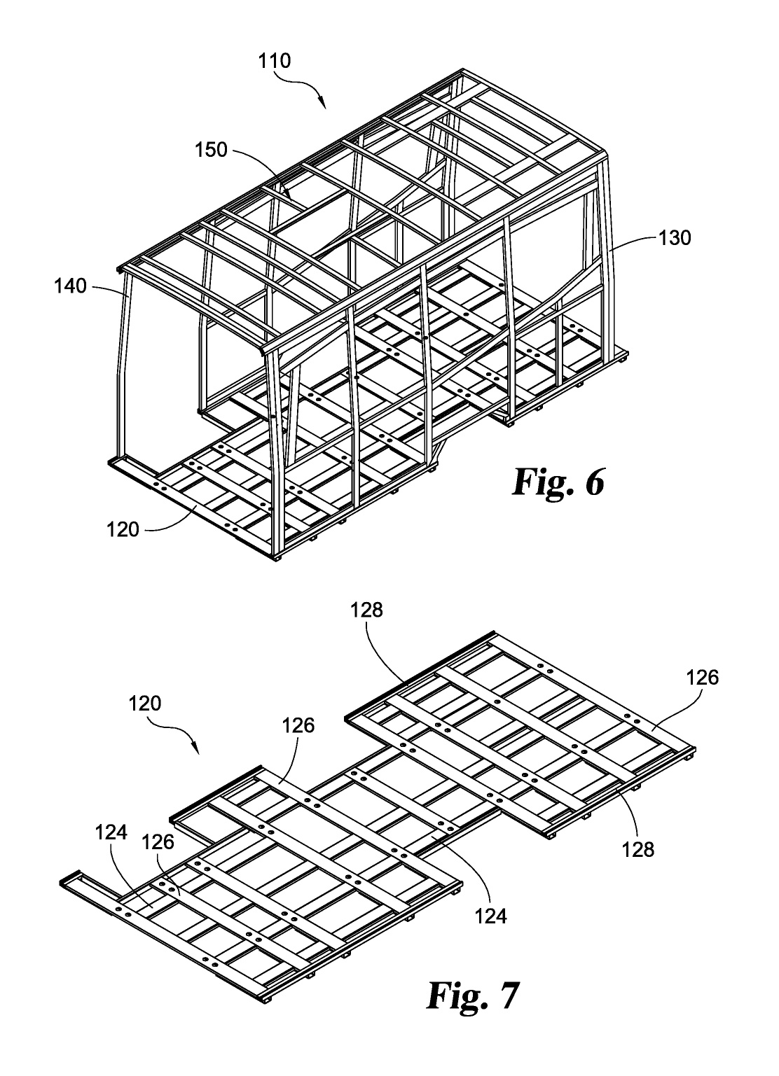

As shown in FIG. 6, a feature of the illustrated embodiment is the structure and assembly process using framing structure or cage 110 which defines and supports rearward compartment 20. In certain embodiments, framing structure 110 can be formed as modular subpanels which can be easily assembled while also providing superior strength and weight characteristics. As illustrated, the subpanels include floor 120, left side 130, right side 140 and roof 150 panels. Optionally a rear subpanel can also be used.

A floor section, for example formed by floor subpanel 120, is illustrated in FIG. 7. Floor subpanel 120 can be formed from an interlocking grid of longitudinal members 124 and lateral members 126. As used herein for ease of reference, but not intended to be limiting, longitudinal is intended to mean oriented along the forward to rearward or front-to-back direction or axis of the van while lateral refers to the side-to-side or widthwise direction of the van. The components of floor subpanel 120 can be joined by welding or using fasteners to form a rigid structure.

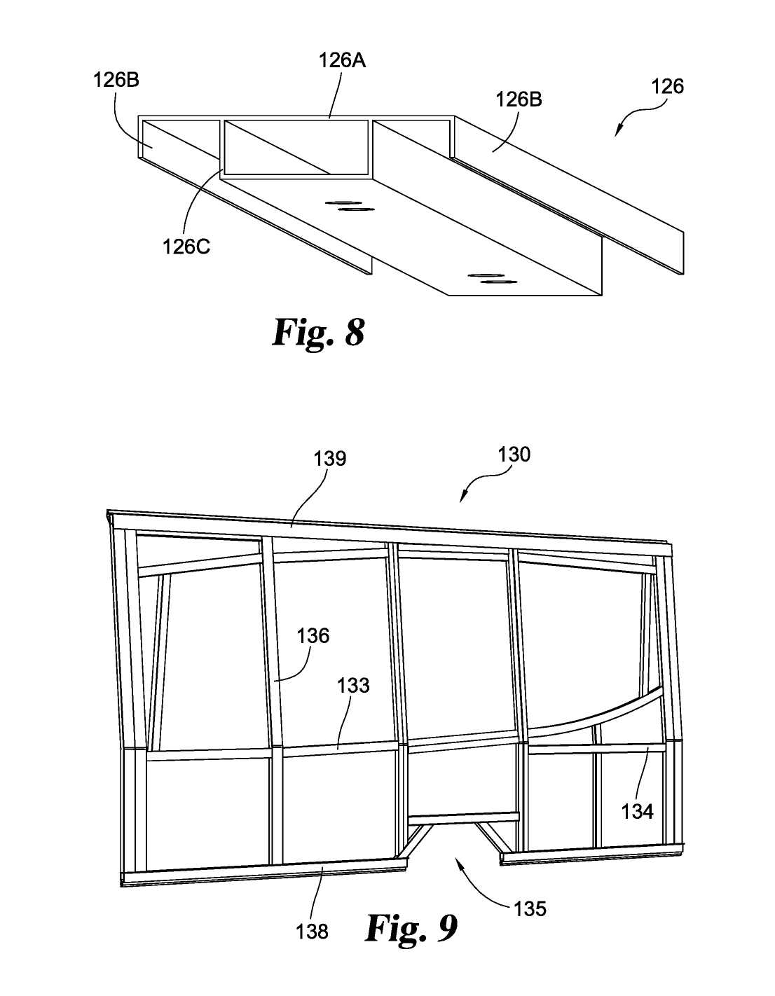

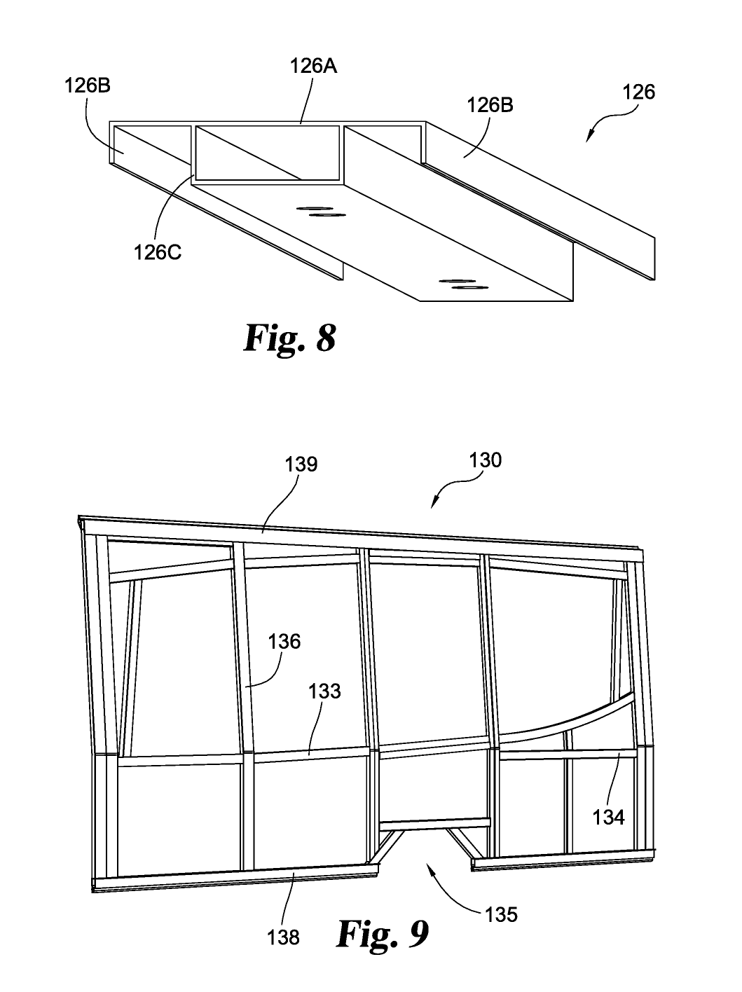

An example lateral member 126 is illustrated in FIG. 8. Longitudinal members 124 may be made in a similar manner. The illustrated lateral member 126 is made as a unitary piece of aluminum. Lateral member 126 includes an upper plate 126A with a length and width defining a support surface, with a pair of flanges 126B extending downward from the lengthwise edges. The flanges help provide strength and rigidity. Lateral member 126 further includes a lengthwise beam portion 126C extending from the lower side of upper plate 126A. Beam portion 126C is formed with a hollow rectangular cross-section, which also assists in providing strength and rigidity. In some embodiments, the width and height of beam portion 126C can be mounted to the rearward chassis by being received in complementary shaped chassis brackets or support beams. In this arrangement, the lower face of upper plate 126A may rest on an upward face of the chassis brackets, while the outer sidewalls of the rectangular section 126C abut inner walls of the chassis brackets. In certain embodiments, lateral member 126 is formed using an extrusion process. The floor panel can be secured to the chassis with welding or fasteners.

As shown in FIG. 7, floor panel 120 includes a pair of side rails 128 arranged along each lateral side of the panel in a longitudinal direction. The side rails 128 may be formed of one or more portions and may be discontinuous, for example to accommodate the wheel areas or an area for passenger steps. Side rails 128 support respective side panels.

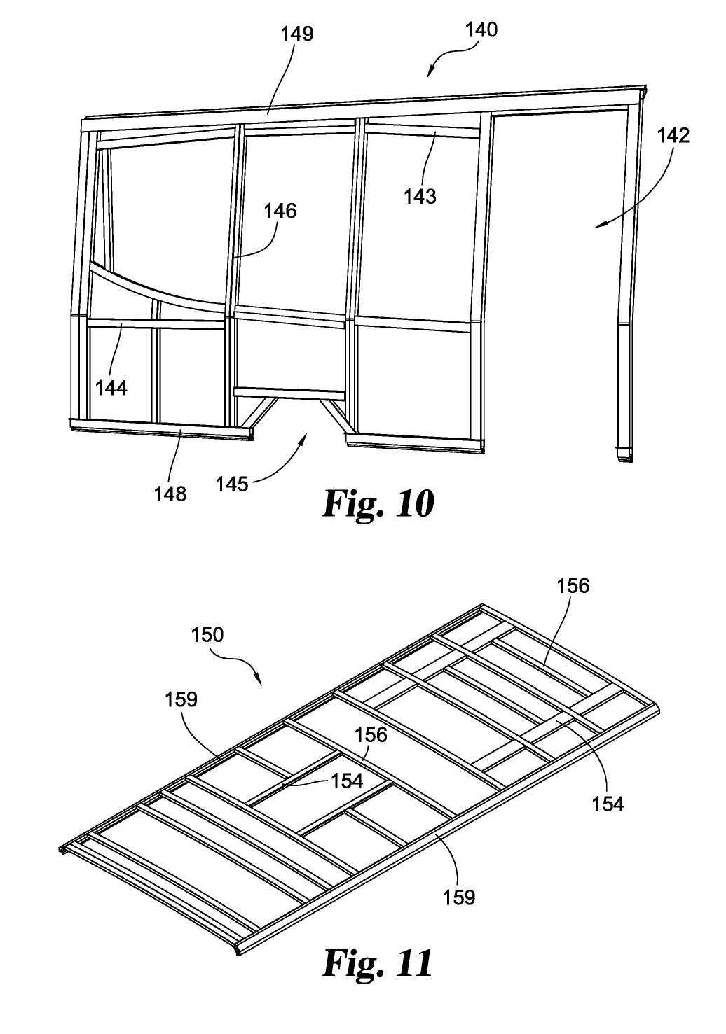

A pair of example left and right side subpanel assemblies 130, 140 is illustrated in FIGS. 9 and 10. Right side panel 140 is generally a mirror image of left side panel 130 with the exception that the framing for right side panel 140 defines an opening 142 for a passenger door. Side panels 130, 140 can be formed from an interlocking grid of horizontal members 134, 144 and vertical members 136, 146. As used herein for ease of reference, but not intended to be limiting, vertical is intended to mean oriented substantially vertical to the ground or support surface while horizontal meals substantially parallel to the ground or support surface. As will be understood by those of skill in the art, substantially vertical or horizontal is intended to encompass variations which may be slightly angled or contoured for aesthetics or functional purposes. The components of the side subpanels can be joined by welding or using fasteners to form a rigid structure. Each subpanel 130, 140 includes framing portions 133, 143 defining framing for respective passenger window arrangements 36, 46.

As shown in FIGS. 9 & 10, side subpanels 130, 140 each include a height extending between a base rail 138, 148 and an upper rail 139, 149, arranged along upper and lower edges of the panel in a longitudinal direction. The base and upper rails may be formed of one or more portions and may be discontinuous, for example to accommodate the wheel areas 135, 145 or an area for passenger steps. Base rails 138, 148 are configured to couple to flooring subpanel 120, and upper rails 139, 149 are configured to couple to roof subpanel 150.

Roof subpanel 150 is illustrated in FIG. 11. Similarly, roof subpanel 150 can be formed from an interlocking grid of longitudinal members 154 and lateral members 156. The components of roof subpanel 150 can be joined by welding or using fasteners to form a rigid structure. Roof subpanel 150 includes a pair of side rails 159 arranged along each lateral side of the panel in a longitudinal direction. The side rails define a pair of longitudinal roof grooves. The side rails 159 may be formed of one or more portions and may be discontinuous. Side rails 159 are configured to couple to respective side panels.

A rear wall subpanel (not shown) can be made in a comparable manner.

Subpanels for the floor, sidewalls, roof and rear wall of cage 110 can be assembled separately and in a standardized manner. Then cage 110 can be assembled in a modular manner. For example, floor subpanel 120 can first be mounted on the rearward chassis section of van 10 to form a floor section. Sidewall panels 130 and 140 are then coupled and secured to the left and right rails 128 of floor subpanel 120. A roof subpanel 150 can then be coupled and secured to the upper rails 139, 149 of sidewall panels 130 and 140. A rear subpanel can then be coupled and secured to the floor subpanel 120, the side subpanels 130, 140 and the roof panel 150 to close the rear of cage 110. The rear subpanel also provides bracing and resists deformation of the substantially rectangular cross-section of cage 110.

The floor, sidewall and roof panels each include lateral or upper/lower edge beams which mate between a sidewall and the floor or a sidewall and the roof via interlocking joints. For example, there is a “hook” in the lower joint to allow the sidewall to be rotated into position. The roof has a drop-down joint from the top (see cross-sections). The joint is secured primarily with adhesive, although one or more fasteners (e.g. screws) can be used to hold the components in position while the adhesive sets. Due to some elastic properties the adhesive may have some vibration damping properties.

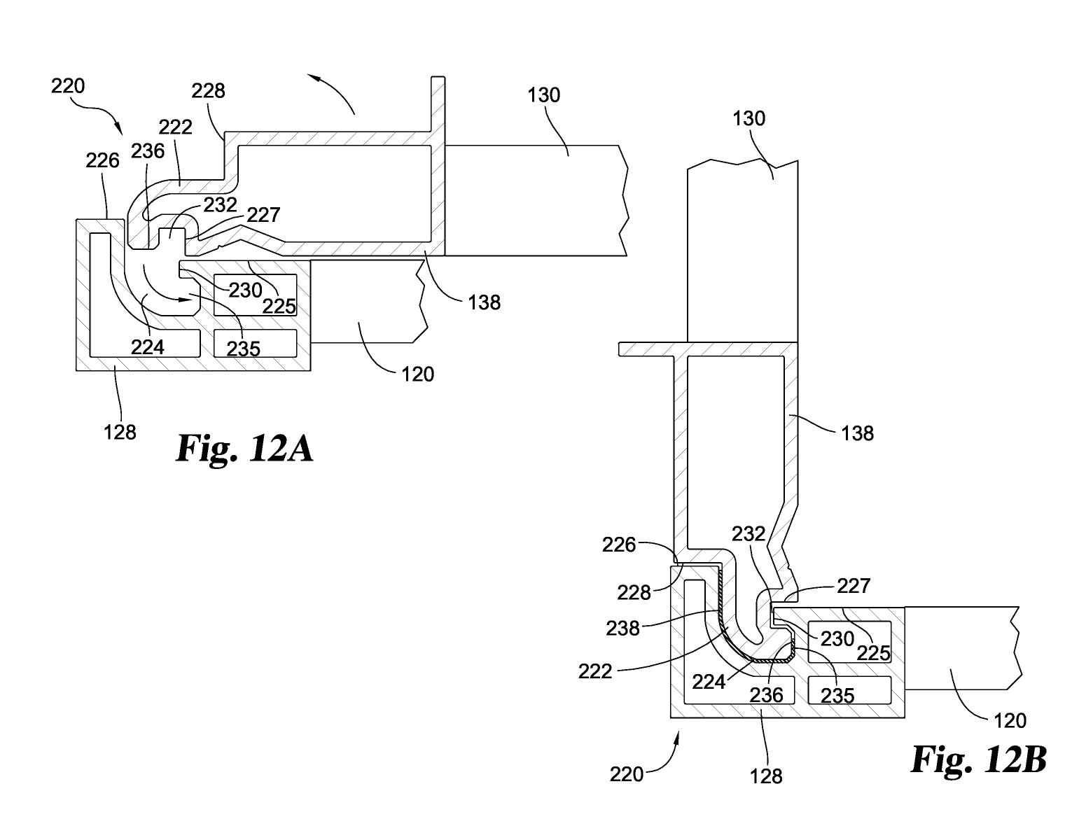

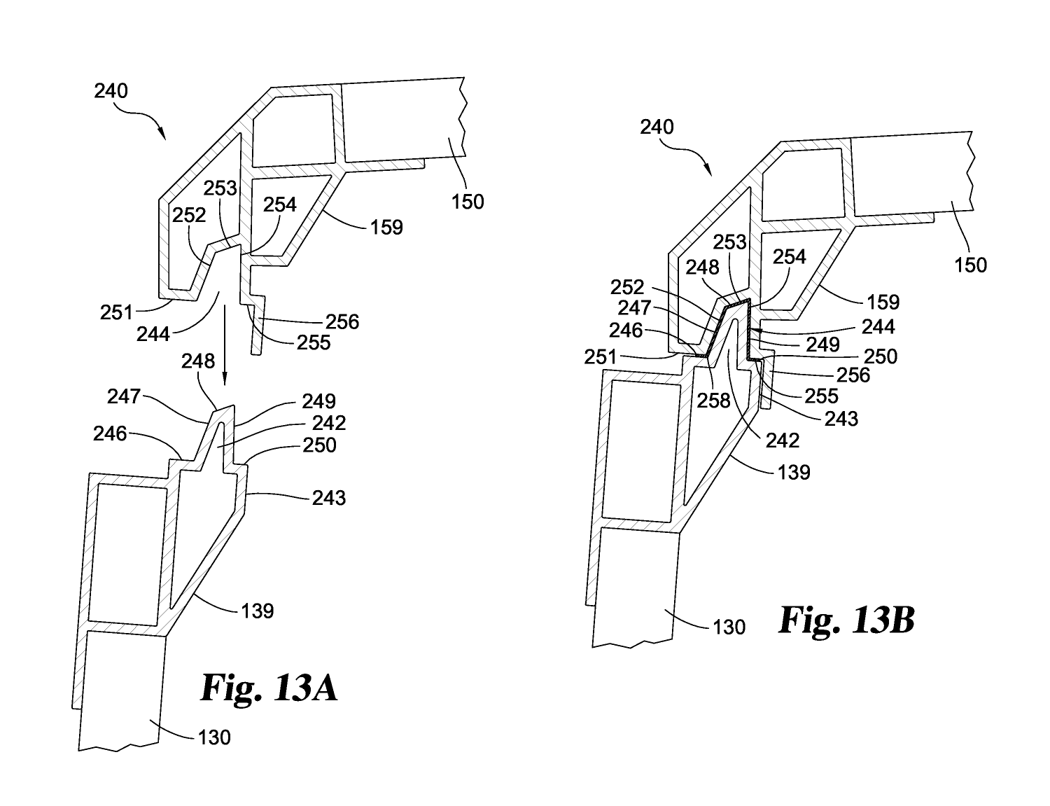

Specialized joints can be used between the subpanels, for example as illustrated in FIGS. 12A-B and FIGS. 13A-B. FIGS. 12A-B illustrate a cross-sectional view of a joint 220 between floor subpanel 120 and side subpanel 130. The joint between floor subpanel 120 and side subpanel 140 is a mirror image. In the illustrated embodiment, rail 128 forms a side or lateral edge of floor subpanel 120. Rail 128 defines a longitudinal mounting slot or base groove 224. Thus, the floor section has a pair of longitudinal base grooves. Groove 224 has a hooked or J shaped cross-section. Specifically, the groove 224 defines a substantially vertically oriented entrance opening. As groove 224 extends downward, it arcuately curves laterally so that it defines a lower volume 235 under lip 230. In the illustrated embodiment, volume 235 extends laterally inward from the vertical portion, although optionally it could curve laterally outward with appropriate modifications to the joint. In the illustrated embodiment, rail 128 has an outer wall portion 226 with an upward facing surface and an inner wall portion 225. Inner wall portion 225 is arranged at a lower height than outer wall portion 226, also with an upward facing surface.

Correspondingly, base rail 138 forms an end or lower edge of side subpanel 130. Base rail 138 has a joint portion formed as a tab or base extension portion 222 arranged to matingly couple with groove 224. Extension portion 222 has a hooked or J shaped cross-section matching the cross-section of groove 224. Specifically, extension portion 222 defines a substantially straight portion aligned with the plane of the subpanel. As extension portion 222 extends, it arcuately curves laterally to a lower end or flange 236. When assembled, lower end 236 is received in lower volume 235 under lip 230. In further detail, one side of extension portion 222 defines a shaped slot 232 or hook opening between an upper shoulder 227 and the lower end or flange 236. As illustrated, slot 232 is rectangular. Rail 138 also defines an outer abutment surface 228 adjacent an outer side of extension portion 222 and substantially perpendicular to the plane of the subpanel. The cross-sectional size of extension portion 222 is slightly less than the cross-sectional size of groove 224, allowing extension portion 222 to be introduced into groove 224 during assembly and also allowing for adhesive 238 to be placed in joint 220.

A method of assembling base joint 220 is illustrated in FIGS. 12A and 12B. FIG. 12A illustrates the pre-assembled arrangement, and FIG. 12B illustrates the assembled arrangement. In FIG. 12A, sidewall subpanel 130 is placed so that the height and area of the subpanel extend in a non-vertical orientation inward from rail 128 and over the floor section, for example on top of and parallel to floor subpanel 120, with extension portion 222 arranged over groove 224. More specifically, the lower end 236 of extension portion 222 is closely adjacent and may abut the outer wall portion 226. The upper shoulder 227 of the extension portion is aligned with an upper surface of lip 230. The hook slot 232 faces downward and is arranged over the entrance to groove 224. The arcuate portions of extension portion 222 and groove 224 are aligned to allow rotational, sliding movement between them.

For assembly, optionally yet preferably an amount of adhesive 238 is placed in groove 224. Subpanel 130 is then rotated upward to the substantially vertical orientation shown in FIG. 12B, as illustrated by the arrows in FIG. 12A. In this arrangement, extension portion 222 enters engages groove 224, with adhesive 238 substantially filling the slight gaps in joint 220. The hooked lower end 236 is received in groove 224 and extends below lip 230. Lip 230 is received in hook slot 232. Sidewall panel 130 is vertically supported by the abutment of rail outer abutment surface 228 on the upward face of outer wall 226, and by the abutment of upward face of lip 230 on upper shoulder 227. The outer abutment surfaces 226, 228 prevent rotation of the sidewall panel past vertical. Sidewall subpanel 130 is then preferably held in place while the adhesive is allowed to cure to permanently secure joint 220. In certain alternate arrangements, the tab and slot arrangement can be reversed, for example with a tab extending from the floor panel introduced into a complementary slot in the sidewall panel.

The adhesive preferably permanently secures joint 220 in the assembled position. Optionally, the adhesive may include some elastic properties which assist in vibration and force damping. For example, the adhesive may be a high performance elastomeric adhesive/sealant that adheres to the joint materials, such as aluminum. The adhesive may incorporate elastic properties, for example an elongation characteristic of 100% or more, more preferably elongation of 250% or more, when cured. Also optionally, one or more fasteners, such as screws or rivets, may be placed through joint 220 to secure it during the curing process, but the fasteners do not add significant strength to the completed joint.

FIGS. 13A-B illustrate a cross-sectional view of an upper joint 240 between side subpanel 130 and roof subpanel 150. The upper joint between roof subpanel 150 and side subpanel 140 is a mirror image. In the illustrated embodiment, upper rail 139 forms an end or upper edge of side subpanel 130. Upper rail 139 defines a longitudinal upper tab portion 242. The illustrated tab portion 242 can be characterized as extending upward and having a truncated, angled cone shaped cross-section. Specifically, tab portion 242 includes an upward and inward angled outer wall 247, a more horizontal yet upward angled top wall 248 and an inner substantially vertically oriented wall 249. Upward facing abutment surfaces 246, 250 are arranged adjacent the outer and inner sides of tab portion 242.

Correspondingly, side rail 159 forms an edge of roof subpanel 150. Side rail 159 defines a longitudinal groove 244 arranged to matingly couple with tab portion 242. The example groove 244 is downward facing and can also be characterized as having a truncated, angled cone shaped cross-section. Specifically, groove portion includes an upward and inward angled outer wall 252, a more horizontal yet upward angled top wall 253 and an inner substantially vertically oriented wall 254. Downward facing abutment surfaces 251, 255 are arranged adjacent the outer and inner edges of the entrance to groove 244. Siderail 159 further includes a downward extending vertical flange 256 which laterally abuts a sidewall portion 243 of upper rail 139. The cross-sectional size of tab portion 242 is slightly less than the cross-sectional size of groove 244, allowing tab portion 242 to be introduced into groove 244 during assembly and also allowing for adhesive 258 to be placed in joint 240.

A method of assembling upper joint 240 is illustrated in FIGS. 13A and 13B. FIG. 13A illustrates the pre-assembled arrangement, and FIG. 13B illustrates the assembled arrangement. In FIG. 13A, the edge of roof subpanel 150 is placed over and parallel to the upper rail 139 of sidewall subpanel 130, with upper tab portion 242 aligned with roof groove 244. Optionally this can be done over both sidewalls simultaneously. Optionally yet preferably an amount of adhesive 258 is placed in groove 244. Subpanel 150 is then lowered to introduce upper tab portion 242 into groove 244. The angled surfaces assist in aligning upper tab portion 242 and guiding it into the correct placement relative to groove 244. In this arrangement, tab portion 242 is received in groove 244 with adhesive 258 substantially filling the slight gaps in joint 240. Roof subpanel 150 is vertically supported by the tab and slot abutment as well as the abutment of outer abutment surfaces 246 to 251, and by the abutment of inward surfaces 250 and 255. Vertical flange 256 further assists in aligning the subpanels and provides lateral bracing and rigidity support to the assembled cage. Roof subpanel 150 is then preferably held in place while the adhesive is allowed to cure to permanently secure joint 240. In certain alternate arrangements, the tab and slot arrangement can be reversed, for example with a tab extending from the roof panel introduced into a complementary slot in the sidewall panel.

The adhesive preferably permanently secures joint 240 in the assembled position. Optionally, the adhesive may include some elastic properties which assist in vibration and force damping. For example, the adhesive may be a high performance elastomeric adhesive/sealant that adheres to the joint materials, which is the same as or a different adhesive as used in joint 220. Also optionally, one or more fasteners, such as screws or rivets, may be placed through joint 240 to secure it during the curing process, but the fasteners do not add significant strength to the completed joint.

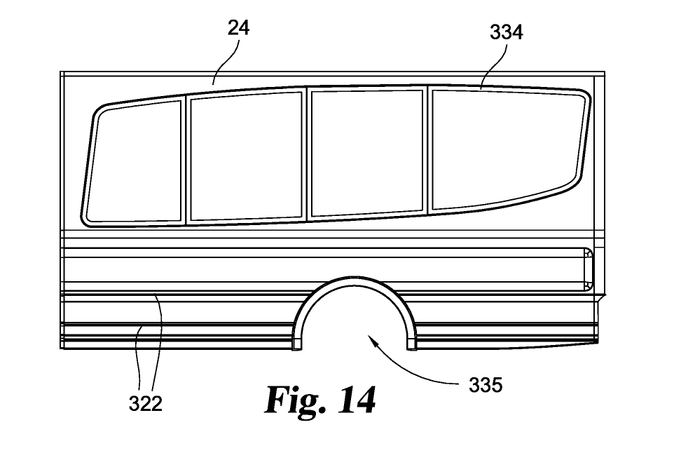

In certain embodiments, the exterior shell of rearward compartment 20 can be made all or partially of pre-made panels, for example made of fiberglass, composite, metal or similar materials. The shell panels can be separately made and then mounted whole onto the framing subpanels and/or cage 110. An example side shell panel 24 is illustrated in FIG. 14. Side shell panels can be formed as one continuous and integral piece extending across the length and width of the respective framing subpanels, and, for example, may include aesthetic aspects such as contours 322. Optionally, contours 322 complement and extend from contour aspects on the sides and doors of cab 40. Side shell panels can include appropriate openings and cut-outs, for example for a wheel well 335 or for passenger door 52. Side shell panel 24 can also include window openings and window frame sections 334, to which windows 36 can be added during assembly of van 10.

As part of the assembly process, for example left side shell panel 24 can be mounted to the corresponding framing subpanel 130. The interior molded shape of shell panel 24 preferably closely matches the shell panel to the subpanel and ensures proper placement and positioning of the shell panel on the subpanel. The shell panel can be mounted using adhesive, fasteners or using other attachment methods. Optionally, shell panel 24 can be mounted to subpanel 130 prior to or after subpanel 130 is placed, erected and/or secured on floor subpanel 120. A similar process can be used with shell panels and subpanels for the right side wall, the roof and rear wall.

In another aspect, in certain embodiments van 10 includes a passenger windshield 32, as illustrated in FIGS. 1-5 & 15. The passenger windshield 32 is positioned and mounted above the driver's windshield 42. This provides enhanced sight options and increased internal light for passengers who may sit several inches higher than the driver. The van shell includes a front panel 22 extending over the cab. Front panel 22 may be placed, angled and contoured to complement and continue the front of cab 40 containing the driver windshield 42. Passenger windshield 32 can be arranged to optically continue the shape, profile and angle of the driver windshield 42 with a minimum of noticeable transition. One option to enhance the continuity of the transition is to minimize the height of front panel portion 322 between the upper edge of the driver windshield 42 and the lower edge of passenger windshield 32. Optionally, the panel portion 322 between the windshields can be in a matching color, for example with a black gloss color matching the tint in the adjacent windshields.

In certain embodiments, the passenger window arrangements 36, 46 and/or the passenger windshield 32 may be mounted to their respective window frames using a wet-set process. The wet-set process includes applying a sealant/adhesive around the perimeter of the window frame, and then placing the window pane directly against the sealant/adhesive and holding it, preferably under pressure, until the sealant/adhesive cures. This can eliminate the need for separate frame or trim around the perimeter of the window pane, as well as the fasteners and space accommodations necessary to set a framed window pane into a vehicle wall. Among other aspects, the wet set method can provide improved external aesthetics by eliminating exposed frame or fastener portions and increasing the usable visible area of the window pane. In certain embodiments disclosed herein, the sidewall panels and passenger windshield panel define window frame portions which are inset from the exterior surface of the respective panel. This allows the window panes to be slightly inset when mounted into the panels, providing a flush or close to flush profile of the window exterior surface with the panel exterior surface. Preferably, each of the sidewalls includes an emergency egress window satisfying the FMVSS 217 standard.

In a further aspect, van 10 includes a contoured roof panel 30. A central surface 342 of roof panel 30 is angled downward and rearward along its length. A pair of side wings 344 extend upward from the central surface 342 along the opposing lateral edges. A spoiler 346 extends laterally across the rear of roof panel 30 between the side wings 344. The roof panel 30 is preferably aerodynamically contoured. The roof panel 30 and support structure can support and hide an air conditioner unit visually and aerodynamically. The roof panel 30 contouring also assists in channeling water, such as rain or snow, off of the vehicle. The interior of the side wings 344 may also be used for support and storage aspects for van 10, such as housing cable runs.

In certain embodiments, the components of cage 110 can be made of lighter weight materials, such as aluminum, rather than more traditional metals such as steel. Using aluminum beams, such as illustrated in FIG. 8, allows the cage components to be significantly lighter while achieving comparable and/or improved strength performance for durability, load carrying and impact resistance. Correspondingly, the van shell can be made of relatively lightweight and thinner yet strong materials such fiberglass or composites, rather than metal panels or thicker fiberglass panels. This can significantly lighten the total weight of the rearward compartment 20 while maintaining and potentially exceeding the necessary strength, load carrying and impact resistance performance requirements. These requirements may include satisfying NHTSA and FMVSS regulations for safety and durability, for example FMVSS 220/221 Occupant Crash and Strength standards.

A chart comparing an example of a van made using an aluminum cage and a fiberglass shell as described herein to a typical van using a steel frame is shown below.

The highlighted sections illustrate example weight reductions in the floor, side walls, roof, rear wall and fiberglass shell assemblies. Weight reduction of the passenger compartment allows the vehicle to provide a greater weight carrying capacity for people and cargo. This can lead to greater capacity being used and/or greater efficiency and increased gas mileage for a given payload. It may also reduce wear and tear on the chassis and engine.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method of assembling a van, comprising:
providing a truck chassis including an engine and cab section and a floor section, the floor section defining a pair of longitudinal base grooves along opposing sides of said floor section;
providing first and second sidewall subpanels, each sidewall subpanel having a height defined between a longitudinal base extension portion having a hooked cross-section and an upper edge defining a longitudinal upper tab portion;
providing a roof subpanel defining a pair longitudinal roof grooves along opposing sides of said roof subpanel;
orienting the height of said first sidewall subpanel to extend inward from a first one of said base grooves and over the floor section in a non-vertical orientation with the base extension portion adjacent to said base groove;
rotating said first sidewall subpanel to a substantially vertical orientation causing said base extension portion to enter and engage the adjacent base groove;
orienting the height of said second sidewall subpanel to extend inward from the second base groove and over the floor section in a non-vertical orientation with the base extension portion arranged adjacent to t second base groove;
rotating said second sidewall subpanel to a substantially vertical orientation causing said base extension portion to enter and engage the adjacent base groove; and,
aligning and lowering said roof subpanel to introduce the upper tab portions of the first and second sidewall panels into said pair of roof grooves.

2. The method of claim 1, comprising inserting an adhesive into each base groove prior to rotating the respective sidewall subpanel.

3. The method of claim 1, comprising inserting an adhesive into each roof groove prior to aligning and lowering said roof subpanel.

4. The method of claim 1, wherein the hooked cross-section portion of each sidewall subpanel defines a downward facing slot when the sidewall subpanel is oriented to extend over the floor section.

5. The method of claim 1, wherein orienting the first sidewall subpanel over the floor section comprises orienting the first sidewall subpanel on top of and substantially parallel to the floor section.

6. The method of claim 1, wherein each sidewall subpanel is formed as an assembly of interlocking substantially horizontal and substantially vertical members.

7. The method of claim 6, wherein said interlocking horizontal and vertical members are made of extruded aluminum.

8. The method of claim 1, wherein each base groove defines a substantially vertically oriented entrance opening.

9. The method of claim 8, wherein each base groove comprises an outer wall portion with an upward facing surface and an inner wall portion with an upward facing surface and wherein the upward facing surface of said inner wall portion is arranged at a lower height than the upward facing surface of said outer wall portion.

10. The method of claim 1, wherein said upper tab portions have a truncated, angled cone shaped cross-section.

11. The method of claim 1, wherein opposing sides of said roof subpanel each comprise a downward extending vertical flange which laterally abuts a sidewall panel portion when the roof subpanel has been lowered into place.

12. A method of assembling a van, comprising:
providing a truck chassis including a floor section, the floor section defining at least one longitudinal base groove along a side of said floor section;
providing at least a first sidewall subpanel having a height and having a base joint portion having a hooked cross-section;
orienting the height of said first sidewall subpanel to extend inward from said base groove in a non-vertical orientation with said base joint portion adjacent to said base groove; and,
rotating said first sidewall subpanel to a substantially vertical orientation so that said hooked cross-section engages the base groove.

13. The method of claim 12, wherein said base groove defines a substantially vertically oriented entrance opening.

14. The method of claim 13, wherein said base groove comprises an outer wall portion with an upward facing surface and an inner wall portion with an upward facing surface and wherein the upward facing surface of said inner wall portion is arranged at a lower height than the upward facing surface of said outer wall portion.

15. The method of claim 12, wherein the engagement of said base joint portion and said base groove prevent rotation of said sidewall panel past vertical.

16. The method of claim 12, wherein orienting said sidewall subpanel over the floor section comprises orienting the subpanel on top of and substantially parallel to the floor section.

17. The method of claim 12, comprising mounting a shell panel onto an exterior side of said first sidewall subpanel.

18. The method of claim 17, wherein said shell panel is formed as one continuous and integral piece extending across the length and width of said first sidewall subpanel.

19. A method of assembling a van, comprising:
providing a truck chassis including a floor section, the floor section defining at least one longitudinal base groove along a side of said floor section;
providing at least a first sidewall panel having a height and having a base joint portion;
orienting said first sidewall panel in a non-vertical orientation with said base joint portion adjacent to said base groove; and,
rotating said first sidewall panel to a substantially vertical orientation so that said base joint portion enters and engages the base groove.

20. The method of claim 19, wherein the engagement of said base joint portion and said base groove prevents rotation of said sidewall panel past vertical.
